(19) United States
(12) Patent Application Publication
(10) Pub. No.: US 2023/0304543 A1
(43) Pub. Date: Sep. 28, 2023

(54) ROTARY ACTUATOR

(71) Applicant: DENSO CORPORATION, Kariya-city (JP)

(72) Inventors: Tomonori SUZUKI, Kariya-city (JP); Takumi SUGIURA, Kariya-city (JP); Akira TAKAGI, Kariya-city (JP)

(21) Appl. No.: 18/327,381

(22) Filed: Jun. 1, 2023

Related U.S. Application Data
(63) Continuation of application No. PCT/JP2021/043560, filed on Nov. 29, 2021.

(30) Foreign Application Priority Data
Dec. 3, 2020 (JP) 2020-201318
Dec. 22, 2020 (JP) 2020-212989

(51) Int. Cl. F16D 28/00; F16H 57/08; H02K 7/116

(52) U.S. Cl. CPC F16D 28/00; F16H 57/082; H02K 7/116; F16D 2127/02

(57) ABSTRACT

A rotary actuator includes a housing, a motor, a speed reducer, and a rotational translation unit. The motor includes a stator that includes a coil and is fixed to the housing, and a rotor that is provided with a magnet and rotates when the coil is energized. The speed reducer decelerates and outputs a torque of the motor. The speed reducer is a planetary gear mechanism including a sun gear, multiple planetary gears, and a ring gear. At least one of projection region components, which are components constituting the speed reducer and are located in a magnet projection region obtained by projecting a magnet in an axial direction, is formed of a non-magnetic material.

### CROSS REFERENCE TO RELATED APPLICATION

The present application is a continuation application of International Patent Application No. PCT/JP2021/043560 filed on Nov. 29, 2021, which designated the U.S. and claims the benefit of priority from Japanese Patent Applications No. 2020-201318 filed on Dec. 3, 2020 and No. 2020-212989 filed on Dec. 22, 2020. The entire disclosures of all of the above applications are incorporated herein by reference.

### TECHNICAL FIELD

The present disclosure relates to a rotary actuator.

### BACKGROUND

Conventionally, a clutch device has been used to permit or block torque transmission.

### SUMMARY

A rotary actuator according to an aspect of the present disclosure includes a housing, a motor, a speed reducer, and a rotational translation unit.

### BRIEF DESCRIPTION OF THE DRAWINGS

The above and other objects, features, and advantages of the present disclosure will become more apparent from the following detailed description with reference to the accompanying drawings. In the drawings:

FIG. 1 is a cross-sectional view showing a clutch device according to a first embodiment;

FIG. 2 is a cross-sectional view showing a part of the clutch device according to the first embodiment; and

FIG. 3 is a cross-sectional view showing a part of a clutch device according to a second embodiment.

### DETAILED DESCRIPTION

Hereinafter, examples of the present disclosure will be described.

According to an example of the present disclosure, a clutch device permits or blocks torque transmission between a first transmission portion and a second transmission portion by changing a state of a clutch to an engaged state or a non-engaged state is known. The clutch device may generally include a rotary actuator including a speed reducer that decelerates and outputs a torque of an electric motor.

A gear used in a speed reducer may be generally formed of a magnetic material. When the gear formed of the magnetic material and a magnet of an electric motor face each other in an axial direction, due to an attraction force in the axial direction caused by a magnetic force of the magnet, a rotational sliding loss of the gear may increase and transmission efficiency may decrease.

A rotary actuator according to an example of the present disclosure includes a housing, a motor, a speed reducer, and a rotational translation unit. The motor includes a stator, which includes a coil and is fixed to the housing, and a rotor, which is provided with a magnet and configured to rotate when the coil is energized. The speed reducer is configured to decelerate and output a torque of the motor. The rotational translation unit including a rotation portion, which is configured to rotate relative to the housing when the torque from the speed reducer is input, and a translation portion, which is configured to move relative to the housing in an axial direction when the rotation portion rotates relative to the housing.

A speed reducer is a planetary gear mechanism including a sun gear, multiple planetary gears, and a ring gear. A torque from a motor is input to the sun gear. Each planetary gear is capable of revolving in a circumferential direction of the sun gear while meshing with the sun gear and rotating on its axis. The ring gear is capable of meshing with the planetary gear. At least one of projection region components, which are components constituting the speed reducer and are located in a magnet projection region obtained by projecting a magnet in an axial direction, is formed of a non-magnetic material. Accordingly, since a decrease in deceleration efficiency is reduced, an interval between the magnet and the speed reducer in the axial direction can be shorten, and a size can be reduced.

Hereinafter, a rotary actuator according to the present disclosure will be described with reference to the drawings. Hereinafter, in multiple embodiments, substantially the same components are denoted by the same reference numerals, and descriptions of the same components will be omitted.

### First Embodiment

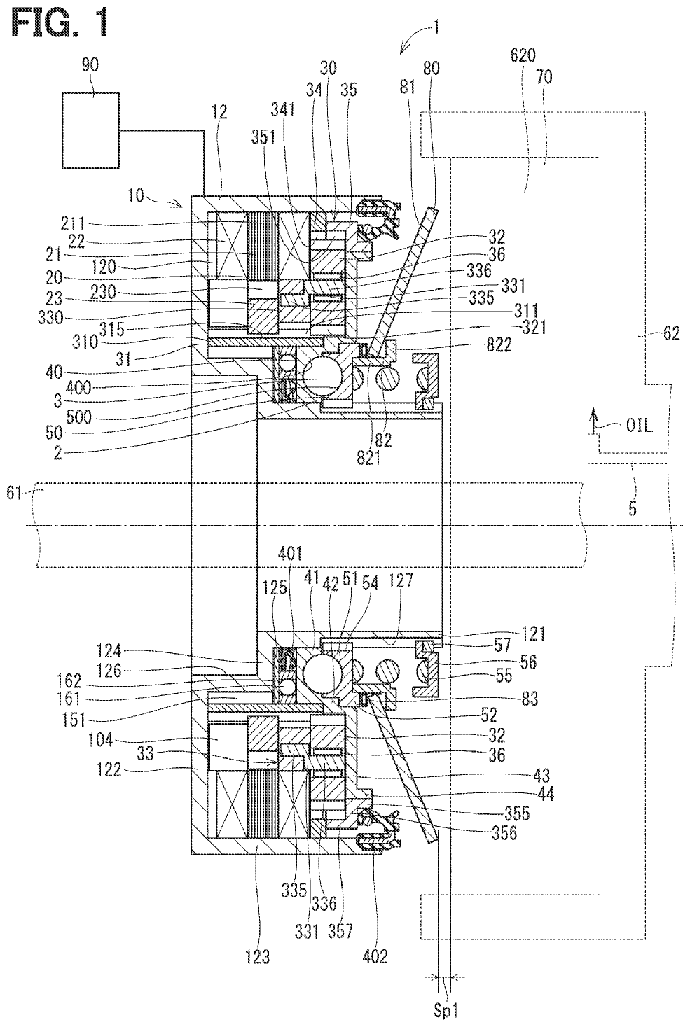

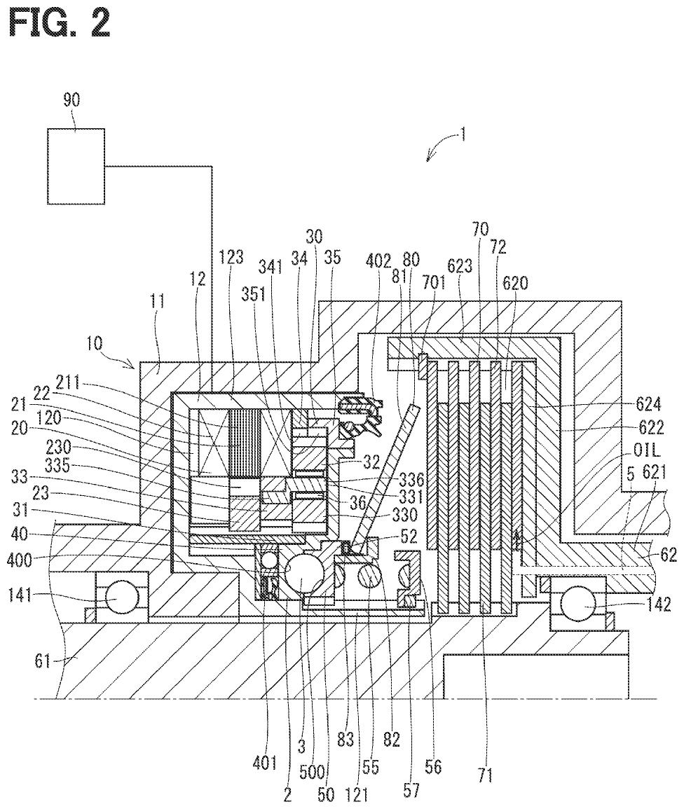

A first embodiment is shown in FIGS. 1 and 2. An electric clutch actuator 10 as a rotary actuator is applied to a clutch device 1. The clutch device 1 is provided, for example, between an internal combustion engine and a transmission of a vehicle, and is used to permit or block torque transmission between the internal combustion engine and the transmission. The vehicle to which the clutch device 1 according to the present embodiment is applied is a vehicle that travels by a drive torque from the internal combustion engine, and may be an electric vehicle, a hybrid vehicle, or the like that can travel by a drive torque from a motor.

The clutch device 1 includes the electric clutch actuator 10, a clutch 70, and a state changing unit 80. The electric clutch actuator 10 includes a housing 12, a motor 20 as an electric motor, a speed reducer 30, and a ball cam 2 as a rotational translation unit.

The clutch device 1 includes an electronic control unit (hereinafter referred to as “ECU”) 90 as a control unit, an input shaft 61 as a first transmission portion, and an output shaft 62 as a second transmission portion.

The ECU 90 is a small computer including a CPU as a calculation means, a ROM, a RAM, and the like as a storage means, an I/O as an input and output means, and the like. The ECU 90 executes calculation according to a program stored in the ROM or the like based on information such as signals from various sensors provided in each part of the vehicle, and controls operations of various devices and machines of the vehicle. In this way, the ECU 90 executes a program stored in a non-transitory tangible storage medium. By executing the program, a method corresponding to the program is executed.

The ECU 90 can control an operation of the internal combustion engine and the like based on the information such as the signals from various sensors. The ECU 90 can also control an operation of the motor 20 to be described later.

The input shaft 61 is connected to, for example, a drive shaft (not shown) of the internal combustion engine, and is rotatable together with the drive shaft. That is, a torque is input to the input shaft 61 from the drive shaft.

The housing 12 is provided between an inner peripheral wall of a fixed body 11 fixed to an engine compartment of the vehicle and an outer peripheral wall of the input shaft 61. A ball bearing is provided between the fixed body 11 and the input shaft 61 and is bearing-supported. The housing 12 includes a housing inner cylinder portion 121, a housing plate portion 122, a housing outer cylinder portion 123, a housing small plate portion 124, a housing step surface 125, a housing small inner cylinder portion 126, a housing-side spline groove portion 127, and the like.

The housing inner cylinder portion 121 is formed in a substantially cylindrical shape. The housing small plate portion 124 is formed in an annular plate shape to extend to a radially outer side from an end portion of the housing inner cylinder portion 121. The housing small inner cylinder portion 126 is formed in a substantially cylindrical shape to extend from an outer edge portion of the housing small plate portion 124 to a side opposite to the housing inner cylinder portion 121. The housing plate portion 122 is formed in an annular plate shape to extend to the radially outer side from an end portion of the housing small inner cylinder portion 126 on a side opposite to the housing small plate portion 124. The housing outer cylinder portion 123 is formed in a substantially cylindrical shape to extend from an outer edge portion of the housing plate portion 122 to the same side as the housing small inner cylinder portion 126 and the housing inner cylinder portion 121. Here, the housing inner cylinder portion 121, the housing small plate portion 124, the housing small inner cylinder portion 126, the housing plate portion 122, and the housing outer cylinder portion 123 are integrally formed of, for example, metal.

As described above, the housing 12 is formed in a hollow and flat shape as a whole.

The housing step surface 125 is formed in an annular planar shape on a surface of the housing small plate portion 124 on a side opposite to the housing small inner cylinder portion 126. The housing-side spline groove portion 127 is formed in an outer peripheral wall of the housing inner cylinder portion 121 to extend in an axial direction of the housing inner cylinder portion 121. Multiple housing-side spline groove portions 127 are formed in a circumferential direction of the housing inner cylinder portion 121.

The housing 12 is fixed to the fixed body 11 by bolts (not shown) or the like such that a part of an outer wall is in contact with a part of a wall surface of the fixed body 11 (see FIG. 2). Here, the housing 12 is provided coaxially with the fixed body 11 and the input shaft 61. In addition, a substantially cylindrical space is formed between an inner peripheral wall of the housing inner cylinder portion 121 and the outer peripheral wall of the input shaft 61.

The housing 12 has an accommodation space 120. The accommodation space 120 is defined by the housing inner cylinder portion 121, the housing small plate portion 124, the housing small inner cylinder portion 126, the housing plate portion 122, and the housing outer cylinder portion 123.

The motor 20 is accommodated in the accommodation space 120. The motor 20 includes a stator 21, a rotor 23, and the like. The stator 21 includes a stator core 211 and a coil 22. The stator core 211 is formed of, for example, a laminated steel plate in a substantially annular shape, and is fixed to an inside of the housing outer cylinder portion 123. The coil 22 is provided on each of multiple salient poles of the stator core 211.

The motor 20 includes a magnet 230. The rotor 23 is formed of, for example, iron-based metal in a substantially annular shape. More specifically, the rotor 23 is formed of, for example, pure iron having a relatively high magnetic property.

The magnet 230 is provided on an outer peripheral wall of the rotor 23. Multiple magnets 230, which are permanent magnets, are provided at equal intervals in a circumferential direction of the rotor 23 such that magnetic poles are alternately arranged.

The electric clutch actuator 10 includes a bearing 151. The bearing 151 is provided on an outer peripheral wall of the housing small inner cylinder portion 126. A sun gear 31, which will be described later, is provided on the radially outer side of the bearing 151. The rotor 23 is provided on the radially outer side of the sun gear 31 so as not to be rotatable relative to the sun gear 31. The bearing 151 is provided in the accommodation space 120 and rotatably supports the sun gear 31, the rotor 23, and the magnets 230.

Here, the rotor 23 is provided on a radially inner side of the stator core 211 of the stator 21 to be rotatable relative to the stator 21. The motor 20 is an inner rotor-type brushless DC motor.

The ECU 90 can control the operation of the motor 20 by controlling electric power supplied to the coil 22. When the electric power is supplied to the coil 22, a rotating magnetic field is generated in the stator core 211, and the rotor 23 rotates. Accordingly, the torque is output from the rotor 23. In this way, the motor 20 includes the stator 21 and the rotor 23 provided rotatably relative to the stator 21, and can output the torque from the rotor 23 by being supplied with electric power.

In the present embodiment, the clutch device 1 includes a rotation angle sensor 104. The rotation angle sensor 104 is provided in the accommodation space 120.

The rotation angle sensor 104 detects a magnetic flux generated from a sensor magnet rotating integrally with the rotor 23, and outputs a signal corresponding to the detected magnetic flux to the ECU 90. Accordingly, the ECU 90 can detect a rotation angle, a rotation speed, and the like of the rotor 23 based on the signal from the rotation angle sensor 104. In addition, the ECU 90 can calculate, based on the rotation angle, the rotation speed, and the like of the rotor 23, a relative rotation angle of a drive cam 40 with respect to the housing 12 and a driven cam 50 to be described later, relative positions of the driven cam 50 and the state changing unit 80 in the axial direction with respect to the housing 12 and the drive cam 40, and the like.

The speed reducer 30 is accommodated in the accommodation space 120. The speed reducer 30 includes the sun gear 31, a planetary gear 32, a carrier 33, a first ring gear 34, a second ring gear 35, and the like.

The sun gear 31 is provided coaxially with and integrally rotatably with the rotor 23. That is, the rotor 23 and the sun gear 31 are formed separately, and are coaxially arranged to be integrally rotatable.

More specifically, the sun gear 31 includes a sun gear main body 310, a sun gear tooth portion 311, and a gear-side spline groove portion 315. The sun gear main body 310 is formed of, for example, metal in a substantially cylindrical shape. The gear-side spline groove portion 315 is formed to extend in the axial direction on an outer peripheral wall of the sun gear main body 310 on one end portion side. Multiple gear-side spline groove portions 315 are formed in a circumferential direction of the sun gear main body 310. The one end portion side of the sun gear main body 310 is bearing-supported by the bearing 151.

Spline groove portions corresponding to the gear-side spline groove portions 315 are formed in an inner peripheral wall of the rotor 23. The rotor 23 is located on the radially outer side of the sun gear 31, and the spline groove portions are provided to be spline-coupled to the gear-side spline groove portions 315. Accordingly, the rotor 23 is not rotatable relative to and is movable in the axial direction relative to the sun gear 31.

The sun gear tooth portion 311 is external teeth formed on an outer peripheral wall of the sun gear 31 on the other end portion side. The torque of the motor 20 is input to the sun gear 31 that rotates integrally with the rotor 23. Here, the sun gear 31 can be said as an input unit of the speed reducer 30. In the present embodiment, the sun gear 31 is formed of, for example, a steel material.

Multiple planetary gears 32 are provided in a circumferential direction of the sun gear 31, and can revolve in the circumferential direction of the sun gear 31 while meshing with the sun gear 31 and rotating on its axis. More specifically, the planetary gears 32 each are formed of, for example, metal in a substantially cylindrical shape, and four planetary gears 32 are provided at equal intervals in the circumferential direction of the sun gear 31 on the radially outer side of the sun gear 31. The planetary gear 32 includes a planetary gear tooth portion 321. The planetary gear tooth portion 321 is external teeth formed on an outer peripheral wall of the planetary gear 32 to mesh with the sun gear tooth portion 311.

The carrier 33 rotatably supports the planetary gears 32 and is rotatable relative to the sun gear 31. More specifically, the carrier 33 is provided on the radially outer side of the sun gear 31. The carrier 33 is rotatable relative to the rotor 23 and the sun gear 31.

The carrier 33 includes a carrier main body 330 and a pin 331. The carrier main body 330 is formed of, for example, metal in a substantially annular shape. The carrier main body 330 is located between the sun gear 31 and the coil 22 in the radial direction, and is located between the rotor 23 and the magnet 230 and the planetary gear 32 in the axial direction. In the present embodiment, the carrier main body 330 is provided on the radially inner side of the stator 21. The planetary gear 32 is located on a side opposite to the housing plate portion 122 with respect to the carrier main body 330 and the coil 22.

The pin 331 includes a connection portion 335 and a support portion 336. The connection portion 335 and the support portion 336 are each formed of, for example, metal in a columnar shape. The connection portion 335 and the support portion 336 are integrally formed such that their respective axes are shifted from each other and are parallel to each other. Therefore, the connection portion 335 and the support portion 336 have a crank-like cross-sectional shape along a virtual plane including their respective axes (see FIG. 1).

The pin 331 is fixed to the carrier main body 330 such that the connection portion 335, which is a portion on one end portion side, is connected to the carrier main body 330. Here, the support portion 336 is provided such that the axis of the support portion 336 is located on the radially outer side of the carrier main body 330 with respect to the axis of the connection portion 335 on a side of the carrier main body 330 opposite to the rotor 23 and the magnet 230 (see FIG. 1). A total of four pins 331 are provided corresponding to the number of planetary gears 32.

The speed reducer 30 includes a planetary gear bearing 36. The planetary gear bearing 36 is, for example, a needle bearing, and is provided between an outer peripheral wall of the support portion 336 of the pin 331 and an inner peripheral wall of the planetary gear 32. Accordingly, the planetary gear 32 is rotatably supported by the support portion 336 of the pin 331 via the planetary gear bearing 36.

The first ring gear 34 includes a first ring gear tooth portion 341 that is a tooth portion that can mesh with the planetary gear 32, and is fixed to the housing 12. More specifically, the first ring gear 34 is formed of, for example, metal in a substantially annular shape. The first ring gear 34 is fixed to the housing 12 such that an outer edge portion is fitted to an inner peripheral wall of the housing outer cylinder portion 123 on a side opposite to the housing plate portion 122 with respect to the coil 22. Therefore, the first ring gear 34 is not rotatable relative to the housing 12.

Here, the first ring gear 34 is provided coaxially with the housing 12, the rotor 23, and the sun gear 31. The first ring gear tooth portion 341 is internal teeth formed in an inner edge portion of the first ring gear 34 to be able to mesh with one end portion side in the axial direction of the planetary gear tooth portion 321 of the planetary gear 32.

The second ring gear 35 includes a second ring gear tooth portion 351 that is a tooth portion that can mesh with the planetary gear 32 and has a different number of teeth from the first ring gear tooth portion 341, and is provided rotatably integrally with the drive cam 40 to be described later. More specifically, the second ring gear 35 is formed of, for example, metal in a substantially annular shape. The second ring gear 35 includes a gear inner cylinder portion 355, a gear plate portion 356, and a gear outer cylinder portion 357. The gear inner cylinder portion 355 is formed in a substantially cylindrical shape. The gear plate portion 356 is formed in an annular plate shape to extend to the radially outer side from one end of the gear inner cylinder portion 355. The gear outer cylinder portion 357 is formed in a substantially cylindrical shape to extend from an outer edge portion of the gear plate portion 356 to a side opposite to the gear inner cylinder portion 355.

Here, the second ring gear 35 is provided coaxially with the housing 12, the rotor 23, and the sun gear 31. The second ring gear tooth portion 351 is “internal teeth” formed on an inner peripheral wall of the gear outer cylinder portion 357 to be capable of meshing with the other end portion side in the axial direction of the planetary gear tooth portion 321 of the planetary gear 32. In the present embodiment, the number of teeth of the second ring gear tooth portion 351 is larger than the number of teeth of the first ring gear tooth portion 341. More specifically, the number of teeth of the second ring gear tooth portion 351 is larger than the number of teeth of the first ring gear tooth portion 341 by a number obtained by multiplying 4, which is the number of planetary gears 32, by an integer.

Since the planetary gear 32 is required to normally mesh with the first ring gear 34 and the second ring gear 35 having two different specifications at the same portion without interference, the planetary gear 32 is designed such that one or both of the first ring gear 34 and the second ring gear 35 are dislocated to keep a center distance of each gear pair constant.

With the above configuration, when the rotor 23 of the motor 20 rotates, the sun gear 31 rotates, and the planetary gear tooth portion 321 of the planetary gear 32 revolves in the circumferential direction of the sun gear 31 while meshing with the sun gear tooth portion 311, the first ring gear tooth portion 341, and the second ring gear tooth portion 351 and rotating on its axis. Here, since the number of teeth of the second ring gear tooth portion 351 is larger than the number of teeth of the first ring gear tooth portion 341, the second ring gear 35 rotates relative to the first ring gear 34. Therefore, between the first ring gear 34 and the second ring gear 35, a minute differential rotation corresponding to a difference in the number of teeth between the first ring gear tooth portion 341 and the second ring gear tooth portion 351 is output as a rotation of the second ring gear 35. Accordingly, the torque from the motor 20 is decelerated by the speed reducer 30 and output from the second ring gear 35. In this way, the speed reducer 30 can decelerate and output the torque of the motor 20. In the present embodiment, the speed reducer 30 constitutes a 3 k-type strange planetary gear speed reducer.

The second ring gear 35 is formed separately from the drive cam 40 to be described later, and is provided rotatably integrally with the drive cam 40. The second ring gear 35 decelerates the torque from the motor 20 and outputs the torque to the drive cam 40. Here, it can be said that the second ring gear 35 is an output unit of the speed reducer 30.

The ball cam 2 includes a drive cam 40 as a rotation portion, a driven cam 50 as a translation portion, and balls 3 as rolling bodies.

The drive cam 40 includes a drive cam main body 41, a drive cam inner cylinder portion 42, a drive cam plate portion 43, a drive cam outer cylinder portion 44, a drive cam groove 400, and the like. The drive cam main body 41 is formed in a substantially annular plate shape. The drive cam inner cylinder portion 42 is formed in a substantially cylindrical shape to extend in the axial direction from an outer edge portion of the drive cam main body 41. The drive cam plate portion 43 is formed in a substantially annular plate shape to extend to the radially outer side from an end portion of the drive cam inner cylinder portion 42 on a side opposite to the drive cam main body 41. The drive cam plate portion 43 is provided to be substantially orthogonal to a rotation shaft. The drive cam outer cylinder portion 44 is formed in a substantially cylindrical shape to extend from an outer edge portion of the drive cam plate portion 43 to a side opposite to the drive cam inner cylinder portion 42. Here, the drive cam main body 41, the drive cam inner cylinder portion 42, the drive cam plate portion 43, and the drive cam outer cylinder portion 44 are integrally formed of, for example, metal.

The drive cam groove 400 is formed to extend in the circumferential direction while being recessed from a surface of the drive cam main body 41 on a drive cam inner cylinder portion 42 side. For example, five drive cam grooves 400 are formed at equal intervals in a circumferential direction of the drive cam main body 41. The drive cam groove 400 is formed with a groove bottom inclined with respect to the surface of the drive cam main body 41 on the drive cam inner cylinder portion 42 side such that a depth becomes shallower from one end to the other end in the circumferential direction of the drive cam main body 41.

The drive cam 40 is provided between the housing inner cylinder portion 121 and the housing outer cylinder portion 123 such that the drive cam main body 41 is located between the outer peripheral wall of the housing inner cylinder portion 121 and an inner peripheral wall of the sun gear 31, and the drive cam plate portion 43 is located on a side opposite to the carrier main body 330 with respect to the planetary gear 32. The drive cam 40 is rotatable relative to the housing 12.

The second ring gear 35 is provided integrally with the drive cam 40 such that an inner peripheral wall of the gear inner cylinder portion 355 is fitted to an outer peripheral wall of the drive cam outer cylinder portion 44. The second ring gear 35 is not rotatable relative to the drive cam 40. That is, the second ring gear 35 is provided integrally rotatably with the drive cam 40. Therefore, when the torque from the motor 20 is decelerated by the speed reducer 30 and output from the second ring gear 35, the drive cam 40 rotates relative to the housing 12. That is, when the torque output from the speed reducer 30 is input to the drive cam 40, the drive cam 40 rotates relative to the housing 12.

The driven cam 50 includes a driven cam main body 51, a driven cam cylinder portion 52, a cam-side spline groove portion 54, a driven cam groove 500, and the like. The driven cam main body 51 is formed in a substantially annular plate shape. The driven cam cylinder portion 52 is formed in a substantially cylindrical shape to extend in the axial direction from an outer edge portion of the driven cam main body 51. Here, the driven cam main body 51 and the driven cam cylinder portion 52 are integrally formed of, for example, metal.

The cam-side spline groove portion 54 is formed to extend in the axial direction in an inner peripheral wall of the driven cam main body 51. Multiple cam-side spline groove portions 54 are formed in a circumferential direction of the driven cam main body 51.

The driven cam 50 is provided such that the driven cam main body 51 is located on a side opposite to the housing step surface 125 with respect to the drive cam main body 41 and the radially inner side of the drive cam inner cylinder portion 42 and the drive cam plate portion 43, and the cam-side spline groove portions 54 are spline-coupled to the housing-side spline groove portions 127. Accordingly, the driven cam 50 is not rotatable relative to the housing 12 and is movable relative to the housing 12 in the axial direction.

The driven cam groove 500 is formed to extend in the circumferential direction while being recessed from a surface of the driven cam main body 51 on a drive cam main body 41 side. For example, five driven cam grooves 500 are formed at equal intervals in the circumferential direction of the driven cam main body 51. The driven cam groove 500 is formed with a groove bottom inclined with respect to the surface of the driven cam main body 51 on the drive cam main body 41 side such that a depth becomes shallower from one end to the other end in the circumferential direction of the driven cam main body 51.

The drive cam groove 400 and the driven cam groove 500 are each formed to have the same shape when viewed from a surface side of the drive cam main body 41 on a driven cam main body 51 side or from a surface side of the driven cam main body 51 on the drive cam main body 41 side.

The balls 3 are formed of, for example, metal in a spherical shape. The balls 3 are provided to be able to roll between five drive cam grooves 400 and five driven cam grooves 500, respectively. That is, five balls 3 are provided in total.

In this way, the drive cam 40, the driven cam 50, and the balls 3 constitute the ball cam 2 as a rolling body cam. When the drive cam 40 rotates relative to the housing 12 and the driven cam 50, the balls 3 roll along the respective groove bottoms in the drive cam grooves 400 and the driven cam grooves 500.

The balls 3 are provided on the radially inner side of the first ring gear 34 and the second ring gear 35. More specifically, most of the balls 3 are provided within a range in the axial direction of the first ring gear 34 and the second ring gear 35.

As described above, the drive cam groove 400 is formed such that the groove bottom is inclined from the one end to the other end. In addition, the driven cam groove 500 is formed such that the groove bottom is inclined from the one end to the other end. Therefore, when the drive cam 40 rotates relative to the housing 12 and the driven cam 50 due to the torque output from the speed reducer 30, the balls 3 roll in the drive cam grooves 400 and the driven cam grooves 500, and the driven cam 50 moves relative to the drive cam 40 and the housing 12 in the axial direction, that is, strokes.

In this way, when the drive cam 40 rotates relative to the housing 12, the driven cam 50 moves relative to the drive cam 40 and the housing 12 in the axial direction. Here, since the cam-side spline groove portions 54 are spline-coupled to the housing-side spline groove portions 127, the driven cam 50 does not rotate relative to the housing 12. In addition, the drive cam 40 rotates relative to the housing 12, but does not move relative to the housing 12 in the axial direction.

In the present embodiment, the clutch device 1 includes a return spring 55, a return spring retainer 56, and a C ring 57. The return spring 55 is, for example, a coil spring, and is provided on the radially outer side of an end portion of the housing inner cylinder portion 121 on a side opposite to the housing small plate portion 124 on a side of the driven cam main body 51 opposite to the drive cam main body 41. One end of the return spring 55 is in contact with a surface of the driven cam main body 51 on a side opposite to the drive cam main body 41.

The return spring retainer 56 is formed of, for example, metal in a substantially annular shape, and is in contact with the other end of the return spring 55 on the radially outer side of the housing inner cylinder portion 121. The C ring 57 is fixed to the outer peripheral wall of the housing inner cylinder portion 121 to lock a surface of the inner edge portion of the return spring retainer 56 on a side opposite to the driven cam main body 51.

The return spring 55 has a force extending in the axial direction. Therefore, the driven cam 50 is urged to the drive cam main body 41 side by the return spring 55 in a state where the ball 3 is sandwiched between the driven cam 50 and the drive cam 40.

As shown in FIG. 2, the output shaft 62 includes a shaft portion 621, a plate portion 622, a cylinder portion 623, and a friction plate 624. The shaft portion 621 is formed in a substantially cylindrical shape. The plate portion 622 is formed integrally with the shaft portion 621 to extend in an annular plate shape from one end of the shaft portion 621 to the radially outer side. The cylinder portion 623 is formed integrally with the plate portion 622 to extend in a substantially cylindrical shape from an outer edge portion of the plate portion 622 to a side opposite to the shaft portion 621. The friction plate 624 is formed in a substantially annular plate shape, and is provided on an end surface of the plate portion 622 on a cylinder portion 623 side. Here, the friction plate 624 is not rotatable relative to the plate portion 622. A clutch space 620 is formed in an inside of the cylinder portion 623.

An end portion of the input shaft 61 passes through an inside of the housing inner cylinder portion 121 and is located on a side opposite to the drive cam 40 with respect to the driven cam 50. The output shaft 62 is provided coaxially with the input shaft 61 on the side opposite to the drive cam 40 with respect to the driven cam 50. A ball bearing 142 is provided between an inner peripheral wall of the shaft portion 621 and an outer peripheral wall of the end portion of the input shaft 61. Accordingly, the output shaft 62 is bearing-supported by the input shaft 61 via the ball bearing 142. The input shaft 61 and the output shaft 62 are rotatable relative to the housing 12.

The clutch 70 is provided between the input shaft 61 and the output shaft 62 in the clutch space 620. The clutch 70 includes inner friction plates 71, outer friction plates 72, and a locking portion 701. Multiple inner friction plates 71 are each formed in a substantially annular plate shape, and are aligned in the axial direction between the input shaft 61 and the cylinder portion 623 of the output shaft 62. The inner friction plate 71 is provided such that an inner edge portion is spline-coupled to the outer peripheral wall of the input shaft 61. Therefore, the inner friction plates 71 are not rotatable relative to the input shaft 61 and are movable relative to the input shaft 61 in the axial direction.

Multiple outer friction plates 72 are each formed in a substantially annular plate shape, and are aligned in the axial direction between the input shaft 61 and the cylinder portion 623 of the output shaft 62. Here, the inner friction plates 71 and the outer friction plates 72 are alternately arranged in the axial direction of the input shaft 61. An outer edge portion of the outer friction plate 72 is spline-coupled to an inner peripheral wall of the cylinder portion 623 of the output shaft 62. Therefore, the outer friction plate 72 is not rotatable relative to the output shaft 62 and is movable relative to the output shaft 62 in the axial direction. Among the multiple outer friction plates 72, the outer friction plate 72 located closest to a friction plate 624 side can come into contact with the friction plate 624.

The locking portion 701 is formed in a substantially annular shape, and is provided such that an outer edge portion is fitted to the inner peripheral wall of the cylinder portion 623 of the output shaft 62. The locking portion 701 can lock an outer edge portion of the outer friction plate 72 located closest to the driven cam 50 among the multiple outer friction plates 72. Therefore, the multiple outer friction plates 72 and the multiple inner friction plates 71 are restricted from coming off from the inside of the cylinder portion 623. A distance between the locking portion 701 and the friction plate 624 is larger than a sum of plate thicknesses of the multiple outer friction plates 72 and the multiple inner friction plates 71.

In an engaged state in which the multiple inner friction plates 71 and the multiple outer friction plates 72 come into contact with each other, that is, are engaged with each other, a frictional force is generated between the inner friction plates 71 and the outer friction plates 72, and relative rotation between the inner friction plates 71 and the outer friction plates 72 is restricted according to a magnitude of the frictional force. On the other hand, in a non-engaged state in which the multiple inner friction plates 71 and the multiple outer friction plates 72 are separated from each other, that is, are not engaged with each other, no frictional force is generated between the inner friction plates 71 and the outer friction plates 72, and the relative rotation between the inner friction plates 71 and the outer friction plates 72 is not restricted.

When the clutch 70 is in the engaged state, the torque input to the input shaft 61 is transmitted to the output shaft 62 via the clutch 70. On the other hand, when the clutch 70 is in the non-engaged state, the torque input to the input shaft 61 is not transmitted to the output shaft 62.

In this way, the clutch 70 transmits the torque between the input shaft 61 and the output shaft 62. The clutch 70 permits torque transmission between the input shaft 61 and the output shaft 62 during the engaged state in which the clutch 70 is engaged, and blocks the torque transmission between the input shaft 61 and the output shaft 62 during the non-engaged state in which the clutch 70 is not engaged. In the present embodiment, the clutch device 1 is a so-called normally open type clutch device that is normally in the non-engaged state.

As shown in FIG. 1, the state changing unit 80 includes a disk spring 81 as an elastic deformation portion, a disk spring retainer 82, and a thrust bearing 83. The disk spring retainer 82 includes a retainer cylinder portion 821 and a retainer flange portion 822. The retainer cylinder portion 821 is formed in a substantially cylindrical shape. The retainer flange portion 822 is formed in an annular plate shape to extend from one end of the retainer cylinder portion 821 to the radially outer side. The retainer cylinder portion 821 and the retainer flange portion 822 are integrally formed of, for example, metal. The disk spring retainer 82 is fixed to the driven cam 50 such that an outer peripheral wall of the other end of the retainer cylinder portion 821 is fitted to an inner peripheral wall of the driven cam cylinder portion 52.

The disk spring 81 is provided such that an inner edge portion is located between the driven cam cylinder portion 52 and the retainer flange portion 822 on the radially outer side of the retainer cylinder portion 821. The disk spring 81 is elastically deformable in the axial direction. The thrust bearing 83 is provided between the driven cam cylinder portion 52 and the disk spring 81.

The disk spring retainer 82 is fixed to the driven cam 50 such that the retainer flange portion 822 can lock one end of the disk spring 81 in the axial direction, that is, the inner edge portion. Therefore, the disk spring 81 and the thrust bearing 83 are restricted from coming off from the disk spring retainer 82 by the retainer flange portion 822.

When the ball 3 is located at one end of the drive cam groove 400 and the driven cam groove 500, a distance between the drive cam 40 and the driven cam 50 is relatively small, and a gap Sp1 is formed between the clutch 70 and the other end of the disk spring 81 in the axial direction, that is, an outer edge portion (see FIG. 1). Therefore, the clutch 70 is in the non-engaged state, and the torque transmission between the input shaft 61 and the output shaft 62 is blocked.

When electric power is supplied to the coil 22 of the motor 20 under the control of the ECU 90, the motor 20 rotates, torque is output from the speed reducer 30, and the drive cam 40 rotates relative to the housing 12. Accordingly, the ball 3 rolls from the one end to the other end of the drive cam groove 400 and the driven cam groove 500. Therefore, the driven cam 50 moves relative to the housing 12 in the axial direction, that is, moves toward the clutch 70 while compressing the return spring 55. Accordingly, the disk spring 81 moves toward the clutch 70.

When the disk spring 81 moves toward the clutch 70 due to the movement of the driven cam 50 in the axial direction, the gap Sp1 decreases, and the other end of the disk spring 81 in the axial direction comes into contact with the outer friction plate 72 of the clutch 70. When the driven cam 50 further moves in the axial direction after the disk spring 81 comes into contact with the clutch 70, the disk spring 81 pushes the outer friction plate 72 toward the friction plate 624 while elastically deforming in the axial direction. Accordingly, the multiple inner friction plates 71 and the multiple outer friction plates 72 are engaged with each other, and the clutch 70 is in the engaged state. Therefore, the torque transmission between the input shaft 61 and the output shaft 62 is permitted.

At this time, the disk spring 81 rotates relative to the driven cam 50 and the disk spring retainer 82 while being bearing-supported by the thrust bearing 83. In this way, the thrust bearing 83 bearing-supports the disk spring 81 while receiving a load in a thrust direction from the disk spring 81.

When a clutch transmission torque reaches a clutch required torque capacity, the ECU 90 stops the rotation of the motor 20. Accordingly, the clutch 70 is in an engagement maintaining state where the clutch transmission torque is maintained at the clutch required torque capacity. In this way, the disk spring 81 of the state changing unit 80 can receive a force in the axial direction from the driven cam 50, and can change the state of the clutch 70 to the engaged state or the non-engaged state according to the relative position of the driven cam 50 in the axial direction with respect to the housing 12 and the drive cam 40.

An end portion of the shaft portion 621 on a side opposite to the plate portion 622 is connected to an input shaft of a transmission (not shown), and the output shaft 62 is rotatable together with the input shaft. That is, the torque output from the output shaft 62 is input to the input shaft of the transmission. The torque input to the transmission is changed in speed by the transmission, and is output to a drive wheel of the vehicle as a drive torque. Accordingly, the vehicle travels.

Next, the 3 k-type strange planetary gear speed reducer employed by the speed reducer 30 according to the present embodiment will be described.

In an electric clutch device as in the present embodiment, it is required to shorten a time required for an initial response to reduce an initial gap (corresponding to the gap Sp1) between a clutch and an actuator. In order to speed up the initial response, it is understood from a rotational motion equation that an inertia moment around an input shaft is required to be reduced. The inertia moment when the input shaft is a solid cylindrical member increases in proportion to a fourth power of an outer diameter when a length and density are constant. In the clutch device 1 according to the present embodiment, the sun gear 31 corresponding to the “input shaft” here is a hollow cylindrical member, and this tendency does not change.

In addition, in the electric clutch device, the required load is very large from several thousand to ten thousand N, and in order to achieve both a high response and a high load, it is necessary to increase a speed reduction ratio of the speed reducer. In the present embodiment, the speed reducer 30 is a 3 k-type strange planetary gear speed reducer in which the sun gear 31 is used as an input element, the second ring gear 35 is used as an output element, and the first ring gear 34 is used as a fixed element. Therefore, an inertia moment around the sun gear 31 can be reduced, and a speed reduction ratio of the speed reducer 30 can be increased. Therefore, both the high response and the high load in the clutch device 1 can be achieved.

In the case of the 3 k-type, since the carrier 33 has only a function of holding the planetary gear 32 at an appropriate position with respect to the sun gear 31, the first ring gear 34, and the second ring gear 35, the bending moment acting between the rotation support shaft (that is, pin 331) of the planetary gear 32 and the carrier main body 330 is small.

Therefore, in the present embodiment, by making the speed reducer 30 as a 3 k-type strange planetary gear speed reducer have a high response and a high load, the planetary gear 32 can be supported from one side in the axial direction, that is, can be supported in a cantilever manner by the carrier main body 330 and the pin 331 without impairing responsiveness and durability of the clutch device 1.

In the present embodiment, the state changing unit 80 includes the disk spring 81 as an elastic deformation portion. With the configuration in which the clutch 70 is pressed by the disk spring 81, a combined spring constant can be reduced as compared with a configuration in which the clutch 70 is pressed by a rigid body, and thus a variation in the load with respect to a variation in the stroke of the driven cam 50 caused by the actuator can be reduced. Accordingly, the variation in the load with respect to the variation in the stroke of the driven cam 50 can be reduced, and a target load can be easily acted on the clutch 70.

The clutch device 1 includes an oil supply portion 5. The oil supply portion 5 is formed in a passage shape in the output shaft 62 such that one end is exposed to the clutch space 620. The other end of the oil supply portion 5 is connected to an oil supply source (not shown). Accordingly, oil is supplied from the one end of the oil supply portion 5 to the clutch 70 in the clutch space 620.

The ECU 90 controls an amount of oil supplied from the oil supply portion 5 to the clutch 70. The oil supplied to the clutch 70 can lubricate and cool the clutch 70. That is, the clutch 70 according to the present embodiment is a wet clutch and can be cooled by oil.

In the present embodiment, the accommodation space 120 is formed between the drive cam 40 and the housing 12, and between the second ring gear 35 and the housing 12. Here, the accommodation space 120 is formed on the inside of the housing 12 on a side opposite to the clutch 70 with respect to the drive cam 40 and the second ring gear 35. The motor 20 and the speed reducer 30 are provided in the accommodation space 120. The clutch 70 is provided in the clutch space 620, which is a space on a side opposite to the accommodation space 120 with respect to the drive cam 40.

The clutch device 1 includes a thrust bearing 161 and a thrust bearing washer 162. The thrust bearing washer 162 is formed of, for example, metal in a substantially annular plate shape, and is provided such that one surface is in contact with the housing step surface 125. The thrust bearing 161 is provided between the other surface of the thrust bearing washer 162 and a surface of the drive cam main body 41 on a side opposite to the driven cam 50. The thrust bearing 161 bearing-supports the drive cam 40 while receiving a load in the thrust direction from the drive cam 40. In the present embodiment, a load in the thrust direction acting on the drive cam 40 from the clutch 70 side via the driven cam 50 acts on the housing step surface 125 via the thrust bearing 161 and the thrust bearing washer 162. Therefore, the drive cam 40 can be stably bearing-supported by the housing step surface 125.

The clutch device 1 includes an inner sealing member 401 and an outer sealing member 402. The inner sealing member 401 and the outer sealing member 402 are oil seals annularly formed of an elastic material such as rubber and a metal ring. An inner diameter and an outer diameter of the inner sealing member 401 are smaller than an inner diameter and an outer diameter of the outer sealing member 402. In addition, the outer sealing member 402 is provided to be located on the radially outer side of the inner sealing member 401 when viewed in the axial direction of the inner sealing member 401.

The inner sealing member 401 is located between the housing inner cylinder portion 121 and the thrust bearing 161 in the radial direction, and is located between the thrust bearing washer 162 and the drive cam main body 41 in the axial direction. The inner sealing member 401 is fixed to the housing inner cylinder portion 121 and is rotatable relative to the drive cam 40.

The outer sealing member 402 is provided between the gear inner cylinder portion 355 of the second ring gear 35 and an end portion of the housing outer cylinder portion 123 on the clutch 70 side. The outer sealing member 402 is fixed to the housing outer cylinder portion 123 and is rotatable relative to the second ring gear 35.

A surface of the drive cam main body 41 on a thrust bearing washer 162 side is slidable on a seal lip portion of the inner sealing member 401. That is, the inner sealing member 401 is provided to come in contact with the drive cam 40. The inner sealing member 401 seals the drive cam main body 41 and the thrust bearing washer 162 in an airtight or liquid-tight manner.

An outer peripheral wall of the gear inner cylinder portion 355 of the second ring gear 35 is slidable on a seal lip portion, which is an inner edge portion of the outer sealing member 402. That is, the outer sealing member 402 is provided to come into contact with the second ring gear 35 that rotates integrally with the drive cam 40 on the radially outer side of the drive cam 40. The outer sealing member 402 seals the outer peripheral wall of the gear inner cylinder portion 355 and the inner peripheral wall of the housing outer cylinder portion 123 in an airtight or liquid-tight manner.

By the inner sealing member 401 and the outer sealing member 402 provided as described above, the accommodation space 120 in which the motor 20 and the speed reducer 30 are accommodated and the clutch space 620 in which the clutch 70 is provided can be maintained in an airtight or liquid-tight manner. Accordingly, for example, even if a foreign matter such as abrasion powder is generated in the clutch 70, the foreign matter can be restricted from entering the accommodation space 120 from the clutch space 620. Therefore, an operation failure of the motor 20 or the speed reducer 30 caused by the foreign matter can be reduced.

In the present embodiment, since the accommodation space 120 and the clutch space 620 are maintained in an airtight or liquid-tight manner by the inner sealing member 401 and the outer sealing member 402, even if the foreign matter such as the abrasion powder is contained in the oil supplied to the clutch 70, the oil containing the foreign matter can be restricted from flowing into the accommodation space 120 from the clutch space 620.

In the present embodiment, the housing 12 is formed to have a closed shape from a portion corresponding to the radially outer side of the outer sealing member 402 to a portion corresponding to the radially inner side of the inner sealing member 401.

In the present embodiment, although the drive cam 40 and the second ring gear 35 forming the accommodation space 120 with the housing 12 rotate relative to the housing 12, the drive cam 40 and the second ring gear 35 do not move relative to the housing 12 in the axial direction. Therefore, when the clutch device 1 is operated, a change in capacity of the accommodation space 120 can be reduced, and generation of a negative pressure in the accommodation space 120 can be reduced. Accordingly, the oil or the like containing the foreign matter can be restricted from being suctioned into the accommodation space 120 from the clutch space 620.

The inner sealing member 401 to come into contact with the inner edge portion of the drive cam 40 slides on the drive cam 40 in the circumferential direction, but does not slide in the axial direction. In addition, the outer sealing member 402 to come into contact with the outer peripheral wall of the gear inner cylinder portion 355 of the second ring gear 35 slides on the second ring gear 35 in the circumferential direction, but does not slide in the axial direction.

As shown in FIG. 1, the drive cam main body 41 is located on a side opposite to the clutch 70 with respect to the drive cam outer cylinder portion 44. That is, the drive cam 40 is bent in the axial direction to be formed such that the drive cam main body 41, which is the inner edge portion of the drive cam 40, and the drive cam outer cylinder portion 44, which is an outer edge portion of the drive cam 40, are located at different positions in the axial direction.

The driven cam main body 51 is provided to be located on the radially inner side of the drive cam inner cylinder portion 42 in the clutch 70 side of the drive cam main body 41. That is, the drive cam 40 and the driven cam 50 are provided in a nested manner in the axial direction.

More specifically, the driven cam main body 51 is located on the radially inner side of the gear plate portion 356, the gear outer cylinder portion 357 of the second ring gear 35, the drive cam plate portion 43, and the drive cam inner cylinder portion 42. In addition, the sun gear tooth portion 311 of the sun gear 31, the carrier 33, and the planetary gears 32 are located on the radially outer side of the drive cam main body 41 and the driven cam main body 51. Accordingly, a size of the clutch device 1 in the axial direction including the speed reducer 30 and the ball cam 2 can be significantly reduced.

In the present embodiment, as shown in FIG. 1, the drive cam main body 41, the sun gear 31, the carrier 33, and the coil 22 are arranged to partially overlap with each other in an axial direction of the drive cam main body 41. In other words, a part of the coil 22 is provided to be located on the radially outer side of a part of the drive cam main body 41, the sun gear 31, and the carrier 33 in the axial direction. Accordingly, the size of the clutch device 1 in the axial direction can be further reduced.

In the present embodiment, the rotor 23 including the magnet 230 is located close to the speed reducer 30. Here, the term “located close to” means that the magnet 230 and components constituting the speed reducer 30 face each other without another member such as a housing being located therebetween, and the speed reducer 30 is located within a range in which a magnetic attraction force of a rotor magnet acts. In addition, it can be considered that the magnet 230 and the speed reducer 30, which is a strange planetary gear mechanism, are connected in series in the axial direction.

Here, when the planetary gear 32 and the carrier 33 facing the magnet 230 are formed of a magnetic material, due to an axial attraction force caused by a magnetic force of the magnet 230, a rotational sliding loss may increase and transmission efficiency may decrease. In addition, when a partition wall is provided between the speed reducer 30 and the rotor 23 or the speed reducer 30 and the rotor 23 are separated to such a degree that the magnetic force of the magnet 230 does not act, the size in the axial direction is increased.

Therefore, in the present embodiment, at least a part of a member in a rotor magnet projection region obtained by projecting the magnet 230 in the axial direction among members constituting the speed reducer 30 is formed of a non-magnetic material. In the present embodiment, the carrier main body 330 and the pin 331, which face the rotor 23 and are in the rotor magnet projection region, are formed of a non-magnetic material. That is, for example, in a state where the sun gear 31, the planetary gear 32, and the ring gears 34 and 35 are formed of a magnetic material and the carrier 33 is formed of a non-magnetic material, among the components constituting the speed reducer 30, some components are formed of a magnetic material and some components are formed of a non-magnetic material.

Since the carrier main body 330 and the pin 331 are formed of a non-magnetic material, a magnetic force of the motor 20 does not act regardless of a distance, and thus a decrease in deceleration efficiency can be reduced. In addition, an axial gap between the magnet 230 and the speed reducer 30 (specifically, the carrier 33) can be reduced. In addition, since the speed reducer 30 can be located close to the rotor 23 in the rotor magnet projection region, a degree of freedom in design in the radial direction can be increased, and the size of the clutch device 1 can be reduced.

As described above, the clutch device 1 according to the present embodiment includes the housing 12, the motor 20, the speed reducer 30, and the ball cam 2. The motor 20 includes the stator 21 that includes the coil 22 and is fixed to the housing 12, and the rotor 23 that is provided with the magnet 230 and rotates when the coil 22 is energized. The speed reducer 30 can decelerate and output the torque of the motor 20. The ball cam 2 includes the drive cam 40 that rotates relative to the housing 12 when the torque is input from the speed reducer 30, and the driven cam 50 that moves relative to the housing 12 in the axial direction when the drive cam 40 rotates relative to the housing 12.

The speed reducer 30 is a planetary gear mechanism including the sun gear 31, the multiple planetary gears 32, and the ring gears 34 and 35. The torque from the motor 20 is input to the sun gear 31. Each planetary gear 32 can revolve in a circumferential direction of the sun gear while meshing with the sun gear 31 and rotating on its axis. The ring gears 34 and 35 can mesh with the planetary gear 32. In the present embodiment, the ring gear includes the first ring gear 34 that meshes with one side in the axial direction of the planetary gear 32, and the second ring gear 35 that has a different number of teeth from the first ring gear 34 and meshes with the other side in the axial direction of the planetary gear 32, and the speed reducer 30 constitutes a strange planetary gear mechanism.

In the present embodiment, at least one of projection region components, which are components constituting the speed reducer 30 and are located in the magnet projection region obtained by projecting the magnet 230 in the axial direction, is formed of a non-magnetic material. By forming the at least one of the projection region components using a non-magnetic material, the decrease in the deceleration efficiency in the speed reducer 30 can be reduced. In addition, the axial gap between the magnet 230 and the projection region component can be reduced, and the degree of freedom in design in the radial direction is increased, which contributes to reduction in the size of the clutch device 1.

The speed reducer 30 includes the planetary gear bearing 36 that rotatably supports the planetary gear 32, and the carrier 33. The carrier 33 includes the pin 331 that holds the planetary gear bearing 36 and the carrier main body 330 that holds the pin. At least one of the planetary gear 32, the planetary gear bearing 36, the pin 331, and the carrier main body 330 is formed of a non-magnetic material.

In the present embodiment, the carrier main body 330 is located between the magnet 230 and the planetary gear 32 in the axial direction, and faces the magnet 230. In addition, the carrier main body 330 is located in the radially inner side of the stator 21 and overlaps the stator 21 at least partially in the axial direction. In other words, at least a part of the carrier main body 330 enters a space on the radially inner side of the stator 21, and is provided in a nested manner in the axial direction. When being located in this way, it is desirable that at least the carrier main body 330 and the pin 331 are formed of a non-magnetic material. Accordingly, the size of the clutch device 1 can be reduced while limiting the decrease in the deceleration efficiency.

In the present embodiment, the carrier main body 330 and the pin 331 that face the magnet 230 are formed of non-magnetic stainless steel (SUS), which is a non-magnetic material. Accordingly, the size of the clutch device 1 can be reduced while ensuring a strength of the component. In addition, an aluminum material or a resin may be used as the non-magnetic material. Accordingly, a rotation inertia moment of the component can be reduced, responsiveness can be improved, and weight can be reduced.

### Second Embodiment

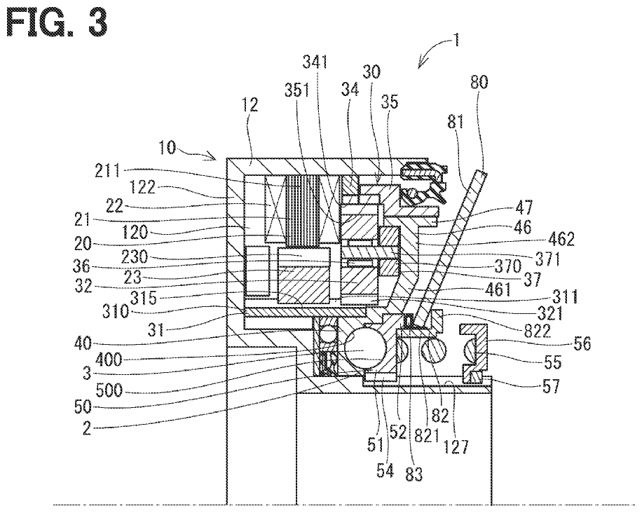

A second embodiment will be described with reference to FIG. 3. The present embodiment differs from the above embodiment mainly in the carrier 37, and this point will be mainly described. FIG. 3 is a diagram corresponding to FIG. 1, and descriptions for a lower half side of the page in FIG. 1 is omitted.

The carrier 37 includes a carrier main body 370 and a pin 371. The carrier main body 370 is provided on a side opposite to the housing plate portion 122 with respect to the planetary gears 32 in an axial direction. That is, in the above embodiment, the rotor 23, the carrier main body 330, and the planetary gear 32 are arranged in this order in the axial direction, whereas in the present embodiment, the rotor 23, the planetary gear 32, and the carrier main body 370 are arranged in this order.

In the present embodiment, the planetary gear 32 and the carrier main body 370 are coaxially arranged, and the pin 371 has a straight shape.

The drive cam 45 includes the drive cam main body 41, the drive cam inner cylinder portion 42, a drive cam plate portion 46, a drive cam outer cylinder portion 47, the drive cam groove 400, and the like. The drive cam plate portion 46 includes an inclined portion 461 and a plate-shaped portion 462. The inclined portion 461 is provided on a drive cam inner cylinder portion 42 side, and is formed to be inclined such that a radially outer side is further away from the housing plate portion 122 than the radially inner side. The plate-shaped portion 462 is formed to extend from the inclined portion 461 to the radially outer side to be substantially orthogonal to a rotation shaft. The drive cam outer cylinder portion 47 is formed in a substantially cylindrical shape from an outer edge portion of the drive cam plate portion 46. The outer edge portion of the drive cam plate portion 46 is located substantially at a center in the axial direction of the drive cam outer cylinder portion 47. The second ring gear 35 is fitted to an outer peripheral wall of the drive cam outer cylinder portion 47.

The carrier main body 370 is located in a space formed between the planetary gear 32 and the drive cam plate portion 46. In the present embodiment, the planetary gear 32 and the planetary gear bearing 36 that face the rotor 23 and are in a rotor magnet projection region are formed of a non-magnetic material.

In the present embodiment, the planetary gear 32 and the planetary gear bearing 36 are located on a magnet 230 side of the carrier main body 330 in the axial direction and facing the magnet 230. When being located in this way, it is desirable that at least the planetary gear 32 and the planetary gear bearing 36 are formed of a non-magnetic material. The same effects as those of the above embodiments can also be obtained in the configuration described above.

In the embodiment, the ball cam 2 corresponds to a “rotational translation unit”, the drive cam 40 corresponds to a “rotation portion”, the driven cam 50 corresponds to a “translation portion”, and the planetary gear bearing 36 corresponds to a “bearing”.

### Other Embodiments

In the above embodiments, at least a part of the carrier is provided to be located on the radially inner side of the stator. In other embodiments, at least a part of the carrier may be provided to be located on a radially outer side of the stator. In addition, in other embodiments, the carrier may be provided to be located on a clutch side with respect to the stator.

In the first embodiment, the carrier main body and the pin are formed of a non-magnetic material, and in the second embodiment, the planetary gear and the planetary gear bearing are formed of a non-magnetic material. In other embodiments, one or more of the planetary gear, the planetary gear bearing, the carrier main body, and the pin may be formed of a non-magnetic material. For example, in the configuration of the first embodiment, at least one of the planetary gear and the planetary gear bearing may be formed of a non-magnetic material in addition to the carrier main body and the pin, and in the configuration of the second embodiment, at least one of the carrier main body and the pin may be formed of a non-magnetic material in addition to the planetary gear and planetary gear bearing.

In the above embodiments, the speed reducer is a strange planetary gear mechanism. In other embodiments, the speed reducer may be a multi-planetary gear mechanism or a planetary gear mechanism.

In the above embodiments, at least a part of the rotational translation unit is provided to be located on the radially inner side of the sun gear. In other embodiments, the rotational translation unit may not be located on the radially inner side of the sun gear. That is, the rotational translation unit may be provided, for example, to be located on the clutch side with respect to the sun gear.

In the above embodiments, regarding the pin constituting the carrier, the support portion that supports the planetary gear is provided on the radially outer side of the connection portion that is connected to the carrier main body. In other embodiments, the support portion may be provided to be located on the radially inner side of the connection portion. In addition, the connection portion of the pin and the support portion may be provided coaxially. That is, the pin may have a straight shape instead of the crank shape when viewed in cross section, whereby the pin can be formed in a simple shape.

In other embodiments, the drive cam as a rotation portion may be formed integrally with the second ring gear of the speed reducer. In addition, in other embodiments, the seal member that maintains the accommodation space and the clutch space in an airtight or liquid-tight manner may not be provided.

In the above embodiments, an example is shown in which the rotational translation unit is a rolling body cam including a drive cam, a driven cam, and a rolling body. On the other hand, in other embodiments, the rotational translation unit may include, for example, a “slide screw” or a “ball screw” as long as the rotational translation unit includes a rotation portion that rotates relative to the housing and a translation portion that moves relative to the housing in the axial direction when the rotation portion rotates relative to the housing.

In the above embodiments, the elastic deformation portion includes the disk spring. In other embodiments, the elastic deformation portion may be, for example, a coil spring or rubber as long as the elastic deformation portion is elastically deformable in the axial direction. In addition, in other embodiments, the state changing unit may include only a rigid body without including the elastic deformation portion.

In the above embodiments, five drive cam grooves, five driven cam grooves, and five balls are provided. In other embodiments, the number of drive cam grooves, driven cam grooves, and balls is not limited to five, and may be any number as long as the number is three or more.

In other embodiments, the torque may be input from the second transmission portion, and output from the first transmission portion via the clutch. In addition, for example, when one of the first transmission portion and the second transmission portion is non-rotatably fixed, the rotation of the other of the first transmission portion and the second transmission portion can be stopped by making the clutch to the engaged state. In this case, the clutch device can be used as a brake device. As described above, the present disclosure is not limited to the above embodiments, and can be implemented in various forms without departing from the spirit of the present disclosure.

The present disclosure has been described in accordance with the embodiments. However, the present disclosure is not limited to the embodiments and the structures. The present disclosure also includes various modification examples and modifications within the scope of equivalents. In addition, various combinations and forms, and further, other combinations and forms which include only one element, more elements, or less elements are included in the scope and the spirit of the present disclosure.

What is claimed is:

1. A rotary actuator comprising:
a housing;
a motor including a stator, which includes a coil and is fixed to the housing, and a rotor, which is provided with a magnet and configured to rotate when the coil is energized;
a speed reducer configured to decelerate and output a torque of the motor; and
a rotational translation unit including a rotation portion, which is configured to rotate relative to the housing when the torque from the speed reducer is input, and a translation portion, which is configured to move relative to the housing in an axial direction when the rotation portion rotates relative to the housing, wherein
the speed reducer is a planetary gear mechanism including
a sun gear configured to input the torque from the motor,
a plurality of planetary gears configured to revolve in a circumferential direction of the sun gear while meshing with the sun gear and rotating on its axis, and
a ring gear configured to mesh with the planetary gears, and
at least one of projection region components, which are components constituting the speed reducer and are located in a magnet projection region obtained by projecting the magnet in the axial direction, is formed of a non-magnetic material, and
the rotor and a rotary component, which constitutes the speed reducer, face each other without another component therebetween.

2. The rotary actuator according to claim 1, wherein
the speed reducer includes
a bearing rotatably supporting the planetary gear, and
a carrier including a pin, which holds the bearing, and a carrier main body, which holds the pin, and
at least one of the planetary gear, the bearing, the pin, and the carrier main body is formed of a non-magnetic material.

3. The rotary actuator according to claim 2, wherein
the carrier main body is located between the magnet and the planetary gear in the axial direction, faces the magnet, and is located in a radially inner side of the stator and overlaps the stator at least partially in the axial direction.

4. The rotary actuator according to claim 2, wherein
the planetary gear and the bearing are arranged to face the magnet on a side closer to the magnet than the carrier main body in the axial direction.

5. The rotary actuator according to claim 1, wherein
at least one of the projection region components is formed of non-magnetic stainless steel, which is a non-magnetic material.

6. The rotary actuator according to claim 1, wherein
at least one of the projection region components is formed of an aluminum material.

7. The rotary actuator according to claim 1, wherein
at least one of the projection region components is formed of a resin.

8. The rotary actuator according to claim 1, wherein
the ring gear includes a first ring gear, which meshes with one side of the planetary gear in the axial direction, and a second ring gear, which has a different number of teeth from that of the first ring gear and meshes with an other side of the planetary gear in the axial direction, and
the speed reducer is a strange planetary gear mechanism.
